(19) United States
(12) Patent Application Publication
(10) Pub. No.: US 2017/0177411 A1
(43) Pub. Date: Jun. 22, 2017

(54) Automated Statistical Analysis Job Chunking

(71) Applicant: Wal-Mart Stores, Inc., Bentonville, AR (US)

(72) Inventor: Steven Edwin Thomas, Bella Vista, AR (US)

(21) Appl. No.: 15/381,568

(22) Filed: Dec. 16, 2016

Related U.S. Application Data
(60) Provisional application No. 62/269,375, filed on Dec. 18, 2015.

(51) Int. Cl. G06F 9/50; G06F 17/30

(52) U.S. Cl. CPC G06F 9/5027; G06F 17/30404

(57) ABSTRACT

The present invention extends to methods, systems, and computer program products for automated statistical analysis job chunking. A computer system provides an interface for a user to submit job requests which pair a script with a query. The computer system and a batch module interoperate with one another to process the job requests and return the job results to the user. The computer system can query the batch module to understand computational resource capability and availability. The computer system can also partition the larger parent job into smaller job chunks for the purpose of multi-threading and to facilitate concurrent parallel processing.

### CROSS-REFERENCE TO RELATED APPLICATIONS

This application claims the benefit of U.S. Provisional Patent Application 62/269,375 filed Dec. 18, 2015, and titled “Automated Statistical Analysis Job Chunking”, the entire contents of which are hereby incorporated herein by reference.

### BACKGROUND

1. Field of the Invention

This invention relates generally to the field of data processing, and, more particularly, to processing large data sets using automated statistical analysis job chunking.

2. Related Art

Retail stores are in the business of selling consumer goods and/or services to customers through multiple channels of distribution. Performance of a retail store can be measured across many factors, including, but are not limited to, (1) cost incurred by the retail store, including direct and indirect cost, (2) markup, which is the amount a seller can charge on top of the actual cost of delivering a product to market in order to make a profit, (3) inventory and distribution, and (4) sales and service strategies. In order to improve performance, retail stores often collect data to understand these factors, and identify areas for improvement. Given these factors and the large number of parameters that can affect store performance, it can be difficult to understand and identify the areas needing improvement.

Analytics can be used to evaluate data that impacts store performance and focus efforts on those areas that provide the largest return on investment. Analytics includes the discovery and communication of meaningful patterns in data. Valuable in areas rich with recorded information, analytics relies on the simultaneous application of statistics, computer programming, and operations research to quantify performance. Analytics often favors data visualization to communicate insight. Different types of analytics include predictive analytics, enterprise decision management, retail analytics, store assortment and stock-keeping unit optimization, marketing optimization and marketing mix modeling, web analytics, sales force sizing and optimization, price and promotion modeling, predictive science, credit risk analysis, and fraud analytics.

Some retail stores or retail chains collect large volumes of data. As such, the challenge exists to find meaningful patterns in the large volumes of collected data in order to describe, predict, and improve business performance. Various relational databases and statistical tools can be used, but processing statistical scripts against large data sets can be an extremely computationally expensive process and can take large amounts of time to complete. To generate forecasts, budgets, and/or schedules against hundreds of data points can require a full time analyst or multiple analysts to manually pull their data into a file, provide the file to a statistical engine, and run either a script or physically enter the algorithms into the statistics tool. This process can take hours to run for each data point and may not be multi-threaded to allow concurrent parallel processing.

As such, extensive computational effort is often utilized (and required) in search of meaningful patterns. Even with the best algorithms and software coupled with the latest computational processing capabilities, some data set processing efforts can take significant amounts of time, for example, weeks or even months to execute. Also, as additional analysts try to process the data, the execution time may increase further still. Given the fast pace of the retail environment, the magnitude of these wait times is typically not acceptable

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates automated statistical analysis job chunking.

FIG. 3 illustrates a flow chart of an example method for automated statistical analysis job chunking.

FIG. 4 illustrates an example user interface for processing data sets using automated statistical analysis job chunking.

### DETAILED DESCRIPTION

The present invention extends to methods, systems, and computer program products for automated statistical analysis job chunking.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In general, aspects of the invention are directed to automated statistical analysis job chunking. A computer system provides an interface for a user to submit job requests which pair a script with a query. The computer system and a batch module interoperate with one another to process the job requests and return the job results to the user.

The computer system is able to query the batch module to understand computational resource capability and availability. The computer system can also partition a larger parent job into smaller job chunks for the purpose of multi-threading and to facilitate concurrent parallel processing.

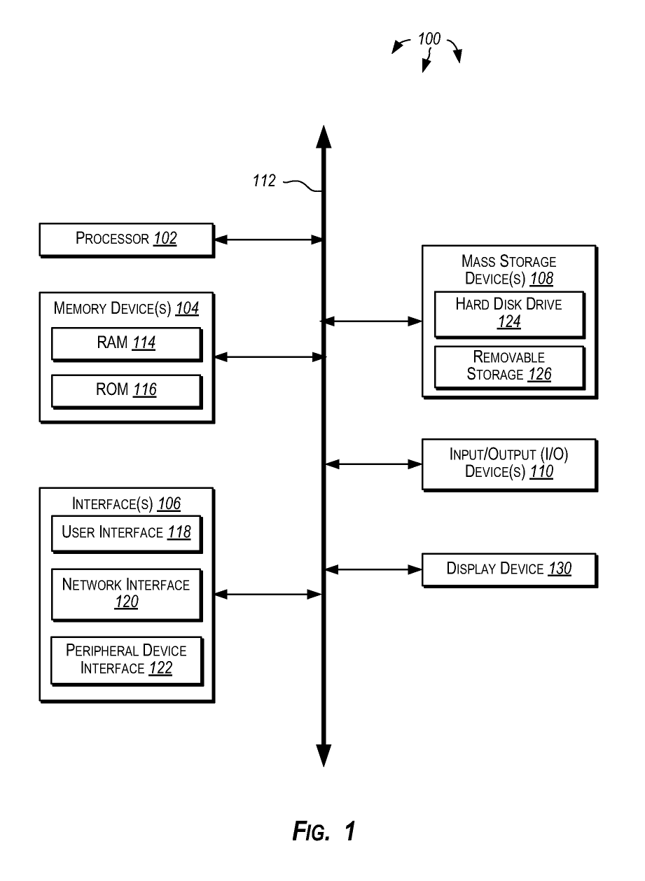

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

In one aspect, a chunking module and job execution module (discussed herein) interoperate to facilitate data analysis of the drivers identified for use with labor standard driven forecasting, budgeting, and scheduling. The chunking module and job execution module can interoperate to schedule linear regression, Mean Absolute Percent Error (MAPE), neural network, and forecasting models over large numbers, for example, hundreds, thousands, or more data points.

Thus, historical data can be pulled from multiple database types (DB2, Teradata, SQL, etc.), via a compliant (e.g., Open Database Connectivity (“ODBC”)) driver. A query can be paired with a statistical model as a job. The job is executed to process the historical data against a variety of algorithm models. For example, an SQL query (or data set) can be paired with a specific R (Statistical Tool) script to execute. Results can be stored to a temporary table or, if generating spreadsheets, graphs, charts or plots to a user's working directory. The chunking module and job execution module interoperate to permit future scheduling of job execution, multiple jobs to execute in parallel, and provide notification of job status completion (e.g., via email) to the user.

Accordingly, aspects of the invention allow jobs (e.g., SQL paired with a statistics model) to be queued for execution at any time of day or day of year. Once the jobs are created, they can be saved and can be executed against different date ranges and store lists. Each user (analyst) can have their own results working directory and/or adhoc table. The user can get email notifications of completion of their job as well as be directed to the results of each job completed. Aspects include a front end application as well as a back end load balancing service that allows dozens of jobs to run concurrently per each server implemented.

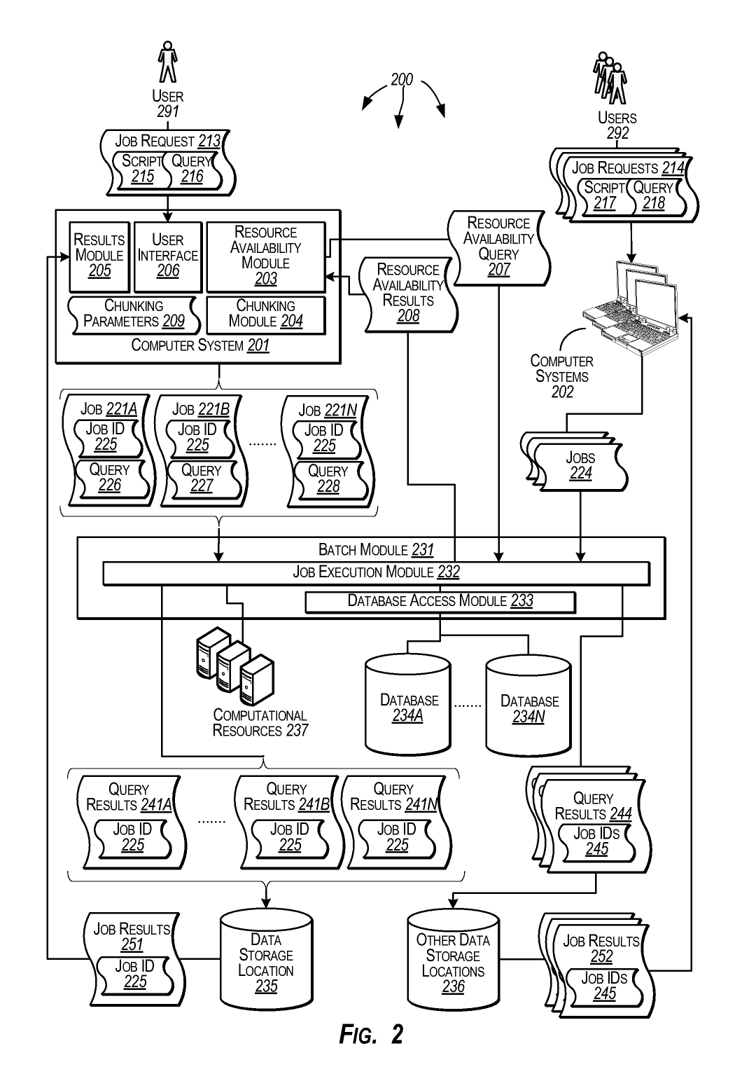

FIG. 2 illustrates an example computer architecture 200 that facilitates automated statistical analysis job chunking. Referring to FIG. 2, computer architecture 200 includes computer system 201, computer systems 202, batch module 231, computational resources 237, databases 234A-234N, and data storage locations 235 and 236. Each of the depicted components can be connected to one another over (or be part of) a network, such as, for example, a PAN, a LAN, a WAN, and even the Internet. Accordingly, each of the depicted components as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Computer system 201 can be one or plurality of computer systems used by one or a plurality of users for the purpose of submitting job requests to be processed. Each computer system 201 can be communicatively coupled with batch module 231.

As depicted, computer system 201 further includes resource availability module 203, chunking module 204, results module 205, and user interface 206.

User interface 206 is configured to be an interface that permits a user and computer system 201 to interact. User interface 206 can be structured to receive job request inputs from the user. User interface 206 can present options for the user to pair predefined or custom scripts with database queries as part of the job request. User interface 206 can present additional functionality for the user to customize job requests, such as specify when a job is to be processed, specify whether a job is to be partitioned (i.e., chunked), and specify whether to receive status updates as a job is being processed, if a job has failed, when a job is completed, etc.

Resource availability module 203 is configured to query batch module 231. When user interface 206 receives a job request from the user, resource availability module 203 can query batch module 231 to determine the availability of computational resources for the purpose of processing the job.

Chunking module 204 is configured to partition the job request from the user into a plurality of smaller jobs. Each smaller job is a subset of a larger parent job and the aggregate of all of the smaller jobs can be viewed as essentially equal to the larger parent job. Chunking module 204 can utilize chunking parameters 209 to specify how the larger parent job is to be partitioned into the plurality of smaller jobs.

In one aspect, chunking parameters 209 are set by a user. For example, the user can specify that a query of data, where the data has been collected over a period of multiple weeks, months, or years, can be queried via a plurality of smaller jobs. Each smaller job is a job to be processed against some subset of the overall time span of collected data. For example, it may be that collected data is to be analyzed for a ten year period. As such, a larger parent job for the ten year period can be partitioned into ten smaller jobs, one job for each year of collected data. In another aspect, the chunking parameters 209 are automatically set by the computer system 201.

Results module 205 is configured to interface with batch module 231 and collect the results of a processed job request. Results module 205 can display the results as unfiltered results data, or results module 205 can output the results of the processed job in the form of a results database table(s), spreadsheet(s), graph(s), plot(s), chart(s), etc.

As depicted, batch module 231 includes job execution module 232 and database access module 233. Generally, job execution module 232 is configured to receive and process job requests received from computer system 201 and/or computer systems 202. Job execution module 232 can utilize database access module 233 to access the data to be processed. The data can be stored in one or more of databases 234A thru 234N. Job execution module 232 can also utilize computational resources 237 to process the jobs. Computational resources 237 can include processor, memory, and storage resources. Computational resources 237 can utilize multi-threading parallel processing techniques to process the jobs using the processor, memory, and storage resources. After jobs are processed, job execution module 232 can facilitate the storage of the job results in data storage locations, such as, for example, data storage locations 235 and/or 236, for the purpose of the user performing post-processing activities on the job results.

A retail store chain may collect data related to the inventory and performance of each of its stores. The data may be collected over a specific time period or over the course of several years or decades. The data may include the inventory details of a store, such as the number and description of items on hand at the close of business each day. The data may also include when shipments are received by a store, and the items received during those shipments. The data may include the detail of each sales transaction such as when and where the transaction occurred, the sales associate who executed the transaction, the items purchased during the transaction, including the quantity of each item, and whether or not the item was on sale, any coupons tendered during the transaction, the method of payment for the transaction, etc. The data may also include the information pertaining to any customer returns, such as the reason for a return, the amount of time between purchase and return, etc.

The data may also include information related to the personnel at each store location. For example, the data may include the number of employees working during a given time period, their assigned departments of labor, the number of managers on site, etc.

The collected data can be stored in one or more of database 234A-234N.

User 291 (e.g., an analyst for the retail store chain) may have an interest in analyzing the collected data to generate forecasts, budgets, and/or schedules. For example, user 291 may have an interest in analyzing the collected data to forecast sales, for example, in the month of November. Additionally, users 292 may also have an interest in analyzing the collected data to forecast personnel needs at specified stores of interest or to forecast inventory needs at other specified stores of interest. User 291 may have a desire to query the performance of a specific set of store locations during the month of November for each of the last ten years.

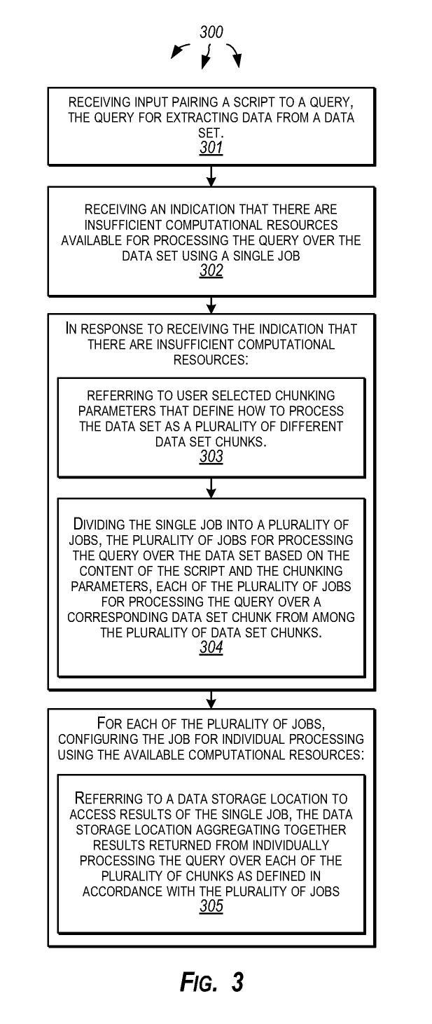

FIG. 3 illustrates a flow chart of an example method 300 for automated statistical analysis job chunking. Method 300 will be described with respect to the components and data of computer architecture 200.

Method 300 includes receiving input pairing a script to a query, the query for extracting data from a data set (301). For example, computer system can receive job request 213 from user 291 via user interface 206. Job request 213 can pair script 215 to query 216. Query 216 can be a query for extracting data from one rom ore of databases 234A-234N. As such, user 291 can utilize user interface 206 to pair script 215 (e.g., a pre-defined sales script) with query 216. Query 216 can be executed against any of a variety of database types such as, for example, DB2, Teradata, SQL, etc. Query 216 can also be executed against a flat file.

Likewise, computer systems 202 can receive jobs requests from users 292 via corresponding user interfaces. Job requests 214 can pair other scripts, for example, script 217, with other queries, for example, query 218. Queries in job requests 214, including query 218, can also be queries for extracting data from one rom ore of databases 234A-234N. Thus, users 292 can similarly utilize user interfaces at computer systems 202 to scripts and queries.

Further, user 291 can utilize user interface 206 to specify job request parameters. Job request parameters can include, for example, a predefined statistics model to be executed against the data. User 291 can specify a single statistics model to be applied or a multitude of models to be applied. Additionally, user 291 can customize the statistical models or generate new statistical models to be utilized. User 291 can specify a date range to be utilized for the data processing. For example, user 291 may be interested in processing only data that has been collected during the past year. User 291 can also specify the stores from which to process the data. User 291 can utilize the data collected from a single store location, a specified set of store locations, or all store locations. Users 292 can specify similar job request parameters utilizing computer systems 202.

Additionally, user 291 can utilize user interface 206 to specify whether or not job request 213 needs to be processed immediately or if it can have a delayed submission. In other embodiments, user 291 can specify an exact date and time when the job should be submitted. For example, user 291 may need to run monthly reports on store performance. User 291 can utilize user interface 206 to schedule the time and frequency at which specified jobs are to be run.

Method 300 includes receiving an indication that there are insufficient computational resources available for processing the query over the data set using a single job (302). For example, resource availability module 203 can access resource availability results 208. Resource availability results 208 can indicate that there is insufficient availability of computational resources 237 for processing query 216 over one or more of databases 234A-234N as a single job. The availability of computation resources 237 can indicate the processor resources (e.g., number of processors available, capabilities of available processors, etc.), memory resources, storage resources, etc., that are available within computational resources 237.

In general, resource availability module 203 and job execution module 232 can interoperate to indicate resource availability results 208 to computer system 201.

In one aspect, upon receipt of job request 213, resource availability module 203 calculates the computational resources for processing query 216 over one or more of databases 234A-234N as a single job. Resource availability module 203 also submits resource availability query 207 to job execution module 232 to request the availability of computational resources 237. In response to receiving resource availability query 207, job execution module 232 ascertains the availability of computation resources 237. Job execution module 232 returns an indication of the availability of computation resources 237 back to resource availability module 203 in resource availability results 208.

In another aspect, job execution module 232 intermittently sends resource availability results 208 to computer system 201, such as, for example, at specified times, at a specified frequency, etc.

For example, query 216 may query the performance of specified store locations during the month of November for each of the last ten years. Thus, query 216 may be over millions, if not billions, of records. Depending on the capability of computational resources 237, and the number of jobs currently being processed by computational resources 237, available resources may be insufficient to process the number of records associated with query 216 in a single job.

In response to receiving the indication that there are insufficient computational resources, method 300 includes referring to user selected chunking parameters that define how to process the data set as a plurality of different data set chunks (303). For example, in response to resource availability results 208, chunking module 204 can refer to chunking parameters 209 to define how to process a data set including data from one or more of databases 234A-234N as a plurality of different data set chunks. That is, chunking module 204 can utilize chunking parameters 209 to define the manner in which query 216 can be divided into a plurality of queries so that the data set from one or more of databases 234A-234N is returned in a corresponding plurality of chunks.

In one aspect, user 291 utilizes user interface 206 to specify chunking parameters 209. Chunking parameters 209 can include whether or not to chunk the job request by store number and a chunk size. For example, user 291 may specify to use a chunk size of 20 stores or 50 stores, for example, for the processing. Additionally, chunking parameters 209 can include whether or not to chunk the job request by date, and what date to chunk the job over. For example, user 291 may specify to chunk the job by year. Thus, one job chunk can be processed over data collected in 2015, another job chunk can be processed over data collected in 2014, etc. Jobs can also be chunked by both store numbers and date ranges.

Likewise, users 292 can utilize user interfaces on computer systems 202 to specify chunking parameters for the queries in job requests.

In response to receiving the indication that there are insufficient computational resources, method 300 includes dividing the single job into a plurality of jobs, the plurality of jobs for processing the query over the data set based on the content of the script and the chunking parameters, each of the plurality of jobs for processing the query over a corresponding data set chunk from among the plurality of data set chunks (304). For example, in response to resource availability results 208, chunking module 204 can utilize chunking parameters 209 to separate job request 213 into smaller jobs 221A, 221B, . . . , 221N, etc. Each of jobs 221A-221N is configured to use fewer computational resources than a larger (parent) job otherwise utilized to satisfy job request 213.

Each of jobs 221A-221N includes job ID 225. Job ID 225 indicates that each of jobs 221A-221N correspond to job request 213 (a larger parent job). Each of jobs 221A-221N also includes a query. For example, job 221A includes query 226, job 221B includes query 227, and job 221N includes query 228. Queries 226, 227, 228 etc. can each be configured to query for a different part (i.e., a chunk) of a larger data set that would otherwise by returned by processing query 216 as a single job.

Similarly, job requests 214 can also be partitioned into a plurality of smaller jobs 224.

In one aspect, a data set for job request 213 is to be chunked by both year and by store number. For example, if query 216 is to be executed against data collected from 150 stores over the past 10 years, user 291 can specify chunking parameters such that each of a plurality of queries are directed to data from 15 stores over a period of 1 year. Thus, data for each year is divided into 10 chunks resulting in a total of 100 chunks to process the data from all 150 stores for the past 10 years. For example, query 226 can be configured to query data from stores 1 thru 15 for year 1. Similarly, query 227 can be configured query data from stores 16 thru 30 for year 1. The pattern can continue including configuring query 228 to query stores 136 thru 150 for year 10.

Computer system 201 can send jobs 221A-221N to batch module 231. Batch module 231 can receive jobs 221A-221N from computer system 201. In one aspect, jobs from among jobs 221A-221N are submitted and received overtime, for example, in accordance with a user defined schedule. Job execution module 232 can utilize computational resources 237 to process each of jobs 221A-221N. Database access module 233 can access one or more of databases 234A thru database 234N, where data associated with jobs 221A-221N is stored.

Additionally, job execution module 232 can receive jobs 224 from users 292. Job execution module 232 can load balance the submitted job requests from user 291 and users 292 and utilize parallel thread processing capability to automatically assign each job to be processed by computational resources 237. For example, if a CPU on one of the processors of computational resources 237 is at 90% of capacity and a CPU on a different processor of computational resources 237 is at 75% of capacity, job execution module 232 can assign one to N jobs to the second processor so that both processors are closer to equally utilized.

As job execution module 232 is processing each job, job execution module 232 can send status updates back to user 291 and users 292 via computer system 201 and computer systems 202, respectively. Alternatively, if a job fails, a job failed notification can be provided back to user 291 and/or users 292. The status updates can be in email format and/or in status updates shown on user interface 206.

For each of the plurality of jobs, configuring the job for individual processing using the available computational resources, method 300 includes referring to a data storage location to access results of the single job, the data storage location aggregating together results returned from individually processing the query over each of the plurality of chunks as defined in accordance with the plurality of jobs (305). For example, results module 205 can access job results 251 from data storage location 235. Job results 251 can contain job ID 225 indicating that job results 251 are associated with job request 213. Similarly, computer systems 202 can access job results 252 from data storage locations 236. Job results 252 can contain job IDs 245 indicating that job results 252 are associated with job requests 214.

Results from job processing can be stored in temporary storage for a user. For example, query (chunk) results 241A-241N can be generated from processing jobs 221A-221N respectively. Query results 241A-241N can be stored in data storage location 235 for subsequent access at computer system 201. Query results 241A-241N can be stored with job ID 225 to indicate that query results 241A-241N correspond to job request 213. Computer system 201 and/or data storage location 235 can combine query results 241A-241N into job results 251. Job results 251 essentially represent results that would have been returned if query 216 had been executed using a single job. Job results 251 also include job ID 225 to indicate that job results 251 correspond to job request 213.

Similarly, query (chunk) results 244 can be generated from processing jobs 221A-221N respectively. Query results 244 can be stored in data storage location 236 for subsequent access at computer systems 202. Query results 244 can be stored with job IDs 245 to indicate that query results 244 correspond to job requests 214. Computer systems 202 and/or data storage location 236 can combine query results 244 into job results 252. Job results 252 essentially represent results that would have been returned if queries 218 had been executed using single jobs. Job results 252 also include job IDs 245 to indicate that job results 252 correspond to job requests 214.

When jobs for a given parent job request complete, a job completion notification can be provided back to user 291 and/or users 292. Alternatively, if the job has failed, a job failed notification can be provided back to user 291 and/or users 292. The notification can be in email format and/or in status updates shown on user interface 206.

Job results 251 associated with job ID 225 can be returned to results module 205 for further processing by user 291. Similarly, job results 252 associated with job IDs 245 can be returned to computer systems 202 for further processing by users 292. For example, job request results 251 and/or 252 can be returned in the form of a results database table, spreadsheet, graphs, plots, charts, etc. User 291 and users 292 can utilize computer system 201 and computer systems 202, respectively, to access the job results 251 and 252 respectively and perform post-processing operations on the job results 251 and 252 respectively.

For example, user 291 can utilize job results 251 to identify that sales of holiday items in the month of November have increased at an average rate of 1% per year at store locations 1 thru 50, but have remained constant at the remaining store locations. User 291 can use job results 251 to determine that more inventory of holiday items at store locations 1 thru 50 during the month of November is appropriate. Furthermore, user 291 can suggest additional promotional activities at store locations 51 thru 150 in the month of November in an effort to increase the sale of holiday items at those store locations.

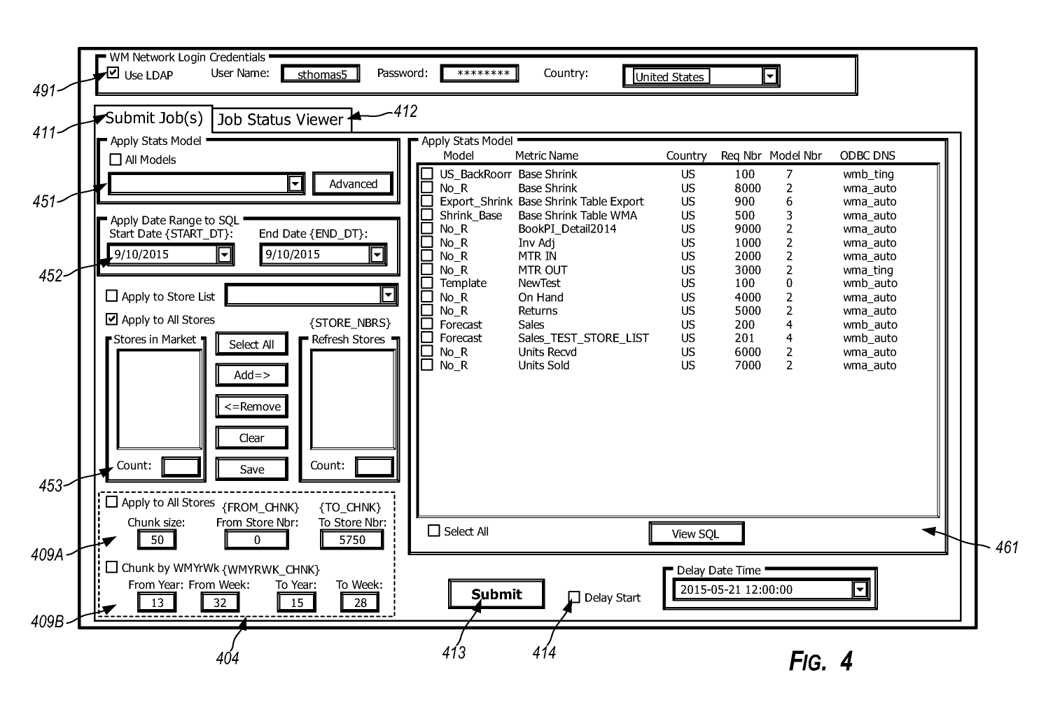

FIG. 4 illustrates an example user interface 400 for processing data sets using automated statistical analysis job chunking. As depicted, user interface 400 includes job submission control panel 411, job status viewer control panel 412, job submission button 413, and job submission scheduling feature 414. User interface 400 also includes a chunking parameters area 404 which includes chunking parameters by store number 409A and chunking parameters by date 409B. User interface 400 also includes a stats model panel 451, a date range panel 452, and a store list panel 453. Further, user interface 400 includes a defined jobs details panel 461, and a user identification panel 491.

In one aspect, user interface 206 includes at least some of the elements of user interface 400. As such, a user can utilize user interface 400 to specify details of the user submitting the job request in user identification panel 491. User identification panel 491 can contain such information as user id of the user submitting the job, user password, and user preferences (such as “use LDAP (Lightweight Directory Access Protocol)”, and country of the user).

User interface 400 can also contain other input fields where a user can specify job request parameters. Job request parameters can include, for example, a predefined statistics model to be executed against the data. The predefined statistic model can be selected from a list of statistics models available in stats model panel 451. The user can specify a single statistics model to be applied or a multitude of models to be applied.

Additionally, a user can customize statistical models or generate new statistical models to be utilized. The user can utilize date range panel 452 to specify a date range to be utilized for the data processing. For example, the user may be interested in processing only data that has been collected during the past year. The user can also utilize store list panel 453 to specify the stores from which to process the data. The user can utilize the data collected from a single store location, a specified set of store locations, or all store locations.

Job details panel 461 can display previously defined jobs that are available for processing. User 291 or users 292 can utilize job details panel 461 to quickly execute common jobs of interest. User 291 or users 292 can also use previously defined jobs as templates and make the necessary edits to customize the job based on the interest of the user.

Additionally, a user can utilize job submission scheduling feature 414 to specify whether or not a job request needs to be processed immediately or if it can have a delayed submission. In other embodiments, the user can specify an exact date and time when the job should be submitted. For example, the user may need to run monthly reports on store performance. The user can utilize job submission scheduling feature 414 to specify the time and frequency at which specified jobs should be run.

A user can click on job submission button 413 to begin the processing of a job.

Upon submission of a job request, a computer system can utilize a resource availability module (e.g., similar to resource availability module 203) communicatively coupled with the job execution module (e.g., similar to job execution module 232) to calculate computational resources needed for processing the query over the data set using a single job. The resource availability module can issue a resource availability query to the job execution module in order to ascertain the resource capability of the computational resources. The job execution module can return the resource availability results to the resource availability module indicating that there are sufficient or insufficient computational resources available for processing the query over the data set using a single job. In some embodiments, the resource availability module can continually query the job execution module to monitor the resource availability of the computational resources.

The user's job request to query the performance of specified store locations during the month of November for each of the last ten years can result in millions, if not billions, of records to be processed. Depending on the capability of the computational resources, and the number of jobs currently being processed by the computational resources, the job request may be too large to process in a single job.

In response to receiving an indication that there are insufficient computational resources, the user interface 400 can refer to user selected chunking parameters in chunking parameters area 404 that define how to process the data set as a plurality of different data set chunks. In some embodiments, the values of the chunking parameters in the chunking parameters area can default to preset values. A user can utilize user interface 400 to modify and/or specify chunking parameters in the chunking parameters area 404.

Chunking parameters can include whether or not to chunk the job request by store number and how large the chunk size should be, as shown in chunking parameters by store number 409A. For example, the user may specify to use a chunk size of 20 stores or 50 stores, for example, for the processing of the job. Additionally, chunking parameters can include whether or not to chunk the job request by date, and what date to chunk the job over, as shown in chunking parameters by date 409B. For example, the user may specify to chunk the job by year. Thus, one job chunk can be processed over data collected in 2015, another job chunk can be processed over data collected in 2014, etc. Jobs can also be chunked by either store numbers or date ranges or by both store numbers and date ranges.

The chunking module can utilize chunking parameters shown in chunking parameters area 404 to partition a job request into smaller a plurality of smaller jobs. Each of the plurality of smaller jobs can be configured to utilize fewer computational resources than a larger (parent) job. Each smaller job can include the job ID associating the smaller job with the larger (parent) job.

As described, a job request can be chunked by both year and by store number. For example, if the job request is to be executed against data collected from 200 stores over the past 6 years, the user can specify: (1) chunking parameters by store number 409A such that each chunk consists of the data from 20 stores and (2) chunking parameters by date 409B such that each chunk consists of the data collected over a period of one year. This means that 6 chunks are required for each year of data, for a total of 60 chunks to process the data from all 200 stores for the past 6 years. Each job chunk can also include a job ID indicating which larger parent job that each smaller job chunk is associated with. For example, the first chunk can include data from stores 1 thru 20 for year 1. Similarly, the second chunk can include data from stores 21 thru 40 for year 1. This pattern can continue until the last chunk (the 60^{th} chunk) includes data from stores 181 thru 200 for year 6. Each chunk contains a job ID indicating the parent job request where each chunk originates from.

The job execution module can receive each of the smaller jobs from the user job request. Each smaller job contains a script paired with a query to be executed against a specified portion (or chunk) of databases where the data resides. The job execution module can load balance the submitted job requests from the user and utilize parallel thread processing to automatically assign each job to be processed by the computational resources.

As the job execution module is processing each job, job execution module can send status updates back to job status viewer control panel 412. Alternatively, if a job has failed, a job failed notification can be provided back to viewer control panel 412. The status updates can be in email format and/or in status updates shown on viewer control panel 412.

As each job is executed, the chunk results can be stored in a data storage location. The chunk results can contain the job ID of the parent job so that the chunk results can be aggregated in the data storage location.

At the conclusion of the processing of smaller jobs for a given job request, a job completion notification can be provided back to job status viewer 412. Alternatively, if the job has failed, a job failed notification can be provided back to job status viewer 412. The notification can be in email format and/or in status updates shown on job status viewer 412.

The job results associated with the job request can be returned to the user for further processing. For example, the job request results can be in the form of a results database table, spreadsheet, graphs, plots, or charts, just to name a few. The user can utilize user interface 400 to access the results and perform post-processing operations on the data.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

1. A processor implemented method for processing a query, the processor implemented method comprising:
receiving user input pairing a script to a query, the query for extracting data from a data set;
receiving an indication that available computational resources at a query processing system are insufficient for processing the query over the data set using a single job;
in response to receiving the indication that available computational resources are insufficient:
accessing chunking parameters that define how to process the data set as a plurality of different data set chunks; and
dividing the single job into a plurality of jobs, the plurality of jobs for processing the query over the data set based on the content of the script and the chunking parameters, each of the plurality of jobs for processing the query over a corresponding data set chunk from among the plurality of data set chunks;
for each of the plurality of jobs, configuring the job for individual processing using the available computational resources at a query processing system; and
accessing results from a data storage location, the data storage location aggregating together results returned from individually processing the query over each of the plurality of chunks to represent results for the single job.

2. The method of claim 1, wherein receiving user input pairing a script to a query comprises receiving input wherein the input pairs an R script with a Structured Query Language (SQL) query.

3. The method of claim 1, wherein receiving user input pairing a script to a query comprises receiving input wherein the script includes one or more statistical operations.

4. The method of claim 1, wherein receiving user input pairing a script to a query comprises receiving input wherein the query is over one of a database or a flat file.

5. The method of claim 1, wherein receiving an indication that available computational resources are insufficient comprises receiving an indication that available resources at a batch query processing system are insufficient.

6. The method of claim 1, wherein receiving an indication that available computational resources are insufficient comprises receiving an indication that one or more of: available memory resources and available processor resources are insufficient.

7. The method of claim 1, wherein, for each of the plurality of jobs, configuring the job for individual processing comprises configuring the job for individual processing in accordance with a user defined schedule.

8. The method of claim 1, further comprising prior to accessing results from the data storage location, receiving a status message related to completion of the plurality of jobs.

9. The method of claim 1, further comprising configuring the accessed results for display in the form of: a results database table, a spreadsheet, a graph, a plot, or a chart.

10. The method of claim 1, wherein, for each of the plurality of jobs, configuring the job for individual processing comprises configuring the job for individual processing in accordance with a user defined sequencing (or ordering) of job execution.

11. The method of claim 1, wherein, for each of the plurality of jobs, configuring the job for individual processing comprises configuring the job for individual processing in accordance with a user defined schedule.

12. The method of claim 1, further comprising notifying the user of the status of the job progress, including notifying the user when a job is complete or if it has failed.

13. A job processing system, the job processing system comprising:
a computer system, the computer system comprising:
one or more processors;
system memory;
one or more computer storage devices having stored thereon computer-executable instructions that, when executed, cause the computer system to:
receive user input pairing a script to a query, the query for extracting data from a data set;
receive an indication that available computational resources at a query processing system are insufficient for processing the query over the data set using a single job;
in response to receiving the indication that available computational resources are insufficient:
access chunking parameters that define how to process the data set as a plurality of different data set chunks; and
divide the single job into a plurality of jobs, the plurality of jobs for processing the query over the data set based on the content of the script and the chunking parameters, each of the plurality of jobs for processing the query over a corresponding data set chunk from among the plurality of data set chunks;
for each of the plurality of jobs, configure the job for individual processing using the available computational resources at a query processing system; and
access results from a data storage location, the data storage location aggregating together results returned from individually processing the query over each of the plurality of chunks to represent results for the single job.

14. The job processing system of claim 13, further comprising a batch module, the batch module comprising:
one or more processors;
system memory;
one or more computer storage devices having stored thereon computer-executable instructions that, when executed, cause the batch module to:
receive a job request, the job request pairing a script to a query, the query for extracting data from a data set;
send an indication that there are insufficient computational resources available for processing the query over the data set using a single job;
subsequent to sending the indication that there are insufficient computational resources, receive a plurality of jobs, each of the plurality of jobs configured to query a subset of the data set;
for each of the plurality of jobs:
submit the job for processing using the available computational resources; and
store results of the job at a data storage location, the data storage location for aggregating together results returned from each of the plurality of jobs to provide a result for job request.

15. A computer program product for use at a computer system, the computer program product for implementing a method for processing a query, the computer program product comprising one or more computer storage devices having stored thereon computer-executable instructions that, when executed at a processor, cause the computer system to perform the method, including the following:
receive user input pairing a script to a query, the query for extracting data from a data set;
receive an indication that available computational resources at a query processing system are insufficient for processing the query over the data set using a single job;
in response to receiving the indication that available computational resources are insufficient:
access chunking parameters that define how to process the data set as a plurality of different data set chunks; and
divide the single job into a plurality of jobs, the plurality of jobs for processing the query over the data set based on the content of the script and the chunking parameters, each of the plurality of jobs for processing the query over a corresponding data set chunk from among the plurality of data set chunks;
for each of the plurality of jobs, configure the job for individual processing using the available computational resources at a query processing system; and
access results from a data storage location, the data storage location aggregating together results returned from individually processing the query over each of the plurality of chunks to represent results for the single job.

16. The computer program product of claim 15, wherein computer-executable instructions that, when executed, cause the computer system to receive user input pairing a script to a query comprise computer-executable instructions that, when executed, cause the computer system to receive input wherein the input pairs an R script with a Structured Query Language (SQL) query, the R script including one or more statistical operations.

17. The computer program product of claim 13, wherein computer-executable instructions that, when executed, cause the computer system to receive an indication that available computational resources are insufficient comprise computer-executable instructions that, when executed, cause the computer system to receive an indication that available resources at a query processing system are insufficient.

18. The computer program product of claim 13, wherein computer-executable instructions that, when executed, cause the computer system to, for each of the plurality of jobs, configure the job for individual processing comprises computer-executable instructions that, when executed, cause the computer system to configure the job for individual processing in accordance with a user defined sequencing.

19. The computer program product of claim 13, further comprising computer-executable instructions that, when executed, cause the computer system to configure the accessed results for display in the form of: a results database table, a spreadsheet, a graph, a plot, or a chart.

20. The computer program product of claim 13, further comprising computer-executable instructions that, when executed, cause the computer system to notify the user of the status of the job progress, including notifying the user when a job is complete and when a job has failed.
